(19) United States
(12) Patent Application Publication
(10) Pub. No.: US 2003/0097429 A1
(43) Pub. Date: May 22, 2003

(54) Method of forming a website server cluster and structure thereof

(76) Inventors: Wen-Che Wu, Ilan (TW); Chun-Yi Tsai, Kaohsiung (TW); Ching-Hua Chow, Taipei (TW); Hai-Yang Huang, Hsinchu (TW)

Correspondence Address: BIRCH STEWART KOLASCH & BIRCH, PO BOX 747, FALLS CHURCH, VA, 22040-0747, US

(21) Appl. No.: 10/107,483

(22) Filed: Mar. 28, 2002

(30) Foreign Application Priority Data
Nov. 20, 2001 (TW) 90128748

(51) Int. Cl. G06F 15/177

(52) U.S. Cl. 709/220; 709/226

(57) ABSTRACT

A method for forming a Web server cluster and structure thereof. An automatic device is used in present invention to analyze the Web page of an website and then convert it to a distributed Web page tied in with the user's definition, in order to optimize Web resources. Distribution of website loading is thus obtained. The present invention applies an automatic device, a Web translator, to produce a Resource Partition and Location Map. As well, in order to lower the difficulty of implementing dynamic Web pages, a Web converter is applied.

### BACKGROUND OF THE INVENTION

1. Field of the Invention

The present invention relates to a method of forming a Website server cluster and structure thereof, more particularly to a method for forming a Website server cluster and structure thereof by converting and dispatching Web pages.

2. Description of the Related Art

Generally speaking, when Web switch technology develops from Layer 2 to Layer 7, it is difficult to have the same network speed throughout Layers. Thus, the cost of developing products and the price of products increase. It is therefore necessary to develop a cheap switching technology for Layer 7. Web switches applied to World Wide Web use maximize the switching skill of layer 7.

Typically, there are four types of Web server load balance systems, Uniform Resource Locator (URL) redirection, Layer 4 server load balancing, proxy redirection and content parsing. In URL redirection systems, a domain name server (DNS) decodes a URL request received from client, and sends a server's Internet Protocol (IP) address back to the client. An advantage of the above method is its ease of build. Generally, most URL redirection systems dispatch IP address of servers by RoundRobin or Improved Round-Robin methods. For example, even a large portal site with a fixed domain name may connect servers with different IP address. As well, when the user clicks on a hyperlink of the Web page, the URL corresponding to the hyperlink might further correspond to another new URL with certain conversion, with the new URL on a different server. This can be regarded as a sketchy method of Web page-division. The DNS redirection systems have shortcomings that cannot ensure consistency, and there is no Fault Tolerance Mechanism in domain name servers, such that domain name servers have no way to know if some servers are shut down, and clients may connect to the servers which have already been shut down for a long time, thereby giving clients the inaccurate impression that the computer is disconnected.

The second type of Web load balancing system is a Layer 4 server load balancing system, which dispatches IP addresses of servers by dispatchers, based on the Layer 3 and 4 headers in the packets received from clients. The dispatchers are also called load balancers. Layer 3 is referred to as the Network layer and Layer 4 the Transport layer. Generally, packet redirection technology is applied to Layer 4 server load balancing systems comprising Network Address Translation (NAT), as shown in FIG. 1, Direct Routing and Tunneling, as shown in FIG. 2, etc. The dispatching mechanisms comprise Round Robin, Weighted Round Robin, Least connection and Weighted Least connection, etc.

However, the method of dispatching server IP addresses has defects in that the dispatchers must handle every packet received from the clients, thereby creating a bottleneck in the whole system's performance. A shortcoming of the URL redirection system and Layer 4 Server load balancing systems is that data stored in servers must be homogeneous. For example, duplicates of the same Web page must be stored in each server, thereby wasting storage space.

Proxy redirection and content parsing are the third and fourth kinds of Web load balancing systems. They are both heterogeneous distributed systems. Dispatchers must have a capability of analyzing clients' headers of Layer 7 for storing heterogeneous data to different servers. For example, the proxy redirection system shown in FIG. 3 has one connection between client and dispatcher and the other between dispatcher and server. After packets sent from clients have been received by dispatcher, the dispatcher analyzes the clients' headers of Layer 7, application layer, and redirects to servers by the other connection. While the dispatcher can get the headers of Layer 7 and dispatch data to servers according to the headers, system performance isn't improved due to the need for every Layer 7 header to be analyzed by the dispatcher. As shown in FIG. 4, the content parsing system adopts a Layer 7 Web switch and is called Delay-Binding. The switch sends a response to the client to keep a connection between the clients and the switch when receiving a connection-binding request from clients and delays. When the switch has received the packets, the switch redirects the client to servers by analyzing the headers of layer 7 of packets. However, in the delay-binding process the Layer 7 Web switch spends protocol time due to the to- and -fro action, generating a high cost for implementation.

For example, as shown in FIG. 5, the Web switch doesn't send a synchronizing message SYN(CSEQ), carried by the synchronizing signal SYN from client in step 1 to the server until step 4. Also, data has been sent from the client to the Web switch in step 3, but the Web switch does not conduct a binding action until step 7. Finally, in step 8, transfer action is complete. Time from step 1 to step 8 comprises the synchronizing message SYN(CSEQ), acknowledgment (ACK), sequence number and checksum for delivering and waiting, thereby impeding the development of network technology. Consequently, the cost for building a Website will decrease if there is a method with this level of performance without needing a Layer 7 Web switch.

Furthermore, in order to store heterogeneous data to different servers the user must define how to divide Web page data to be stored in different servers, and how to redirect packets to servers. For example, all data can be stored to different servers, depending on file extension or determined URL links. However, Webmasters must define rules by inputting commands no matter what files are stored. Moreover it is difficult for the Content Parsing system to obtain optimized separations and administrations due to the system's lack of performance estimating mechanism of servers and file allocation. It is very difficult for Webmasters to build administration manually when the roles are complex and numerous. The shortcomings of the Layer 4 dispatcher and Layer 7 Web switch follow. First, both must redirect packets or link to servers using an adapter, a dispatcher or a Web switch. The adapter will be the bottleneck of system performance due to excessively heavy loading. Second, in the adapters, it is hard to use commands to separate and administrate data of Web pages appropriately. Third, once some data of Web pages has changed, the system can't allocate data in servers and refresh it because of constraints in automatic and optimizing mechanisms.

### SUMMARY OF THE INVENTION

Accordingly, an object of the present invention is to provide a method of forming a Website server cluster. The present invention converts Web pages to distributed Web pages to decrease Website loading without Web switches in the Website server cluster.

Another object of the present invention is to provide a method of forming a Website server cluster by converting and dispatching Web pages. The present invention optimizes Web page data using automatic devices to analyze Web page resources in the original Website and convert them to distributed Web pages according to

The structure of the present invention includes automatic device for producing a Resource Partition and Location Map, a memory for storing the Resource Partition and Location Map and a plurality of sub-servers. According to this invention, the method for forming a Website server cluster structure comprises the steps of:

Determining an absolute address of a resource of a Web page according to a predetermined database structure and a predetermined resource definition.

Editing the absolute addresses to form a Resource Partition and Location Map.

Performing the absolute address conversion to the sub-server and storing the absolute address to the sub-server if the Web page is a static Web page; and

Storing the Web page to the sub-server, and performing the absolute address conversion to the sub-server according to the Resource Partition and Location Map and the stored Web page when receiving a demanding request from outside if the Web page is a nonstatic Web page.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram of a conventional network using DNS redirection.

FIG. 2 is a diagram of a conventional network using Direct Routing and Tunneling.

FIG. 3 is a diagram of a conventional network using Proxy redirection.

FIG. 4 is a diagram of a conventional network using a Layer 7 Web switch.

FIG. 5 is a diagram of a conventional network in FIG. 4 using Delay-Binding.

FIG. 6 is a diagram of a network structure of the present invention.

FIG. 7(a) is a diagram of a network structure of conventional methods.

FIG. 7(b) is a diagram of a network structure of the present invention.

FIG. 8(a) is a diagram for illustrating links in conventional methods.

FIG. 8(b) is a diagram for illustrating links in the present invention.

FIG. 9 is a diagram of a network structure of the present invention.

FIG. 10 is a diagram of a network structure according to FIG. 6 and FIG. 9.

FIG. 11(a) is a diagram illustrating links in a dynamic Web page of conventional methods.

FIG. 11(b) is a diagram illustrating links in dynamic Web page of the present invention.

FIG. 12 is a diagram of a network structure of the present invention.

FIG. 13 shows the steps of forming a Web server cluster structure of the present invention.

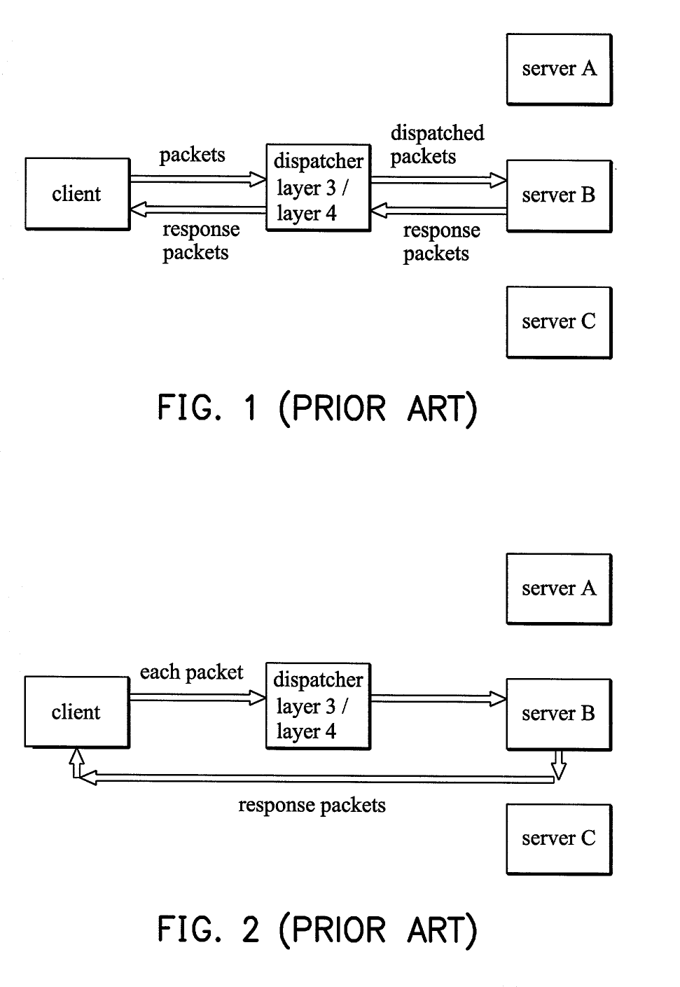

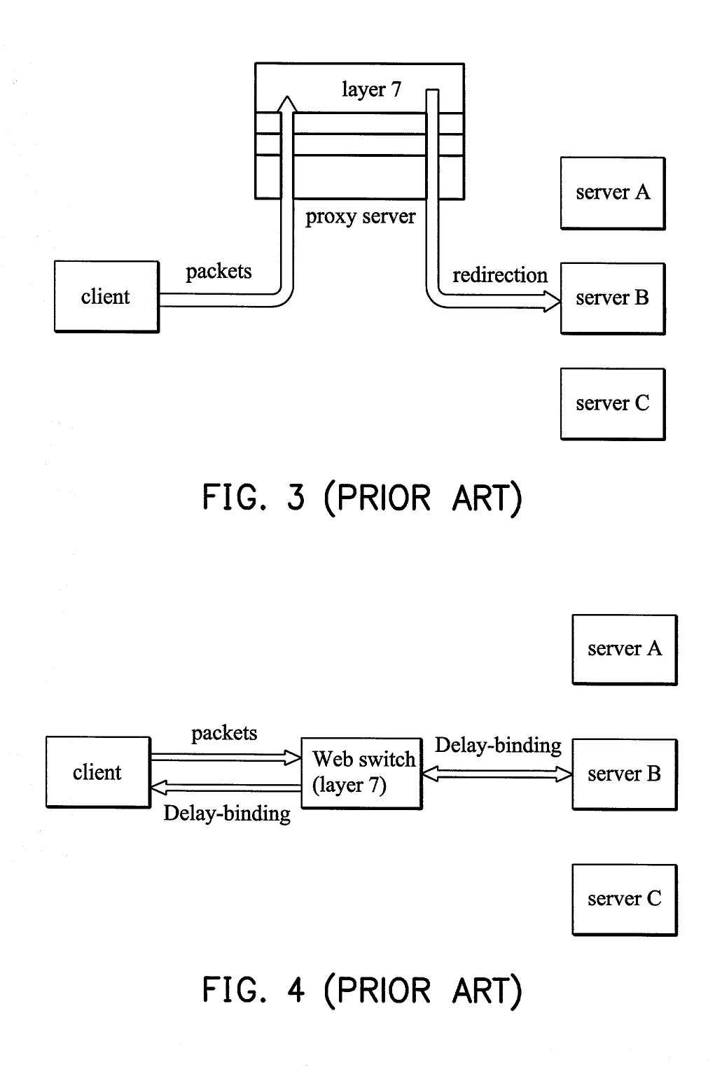

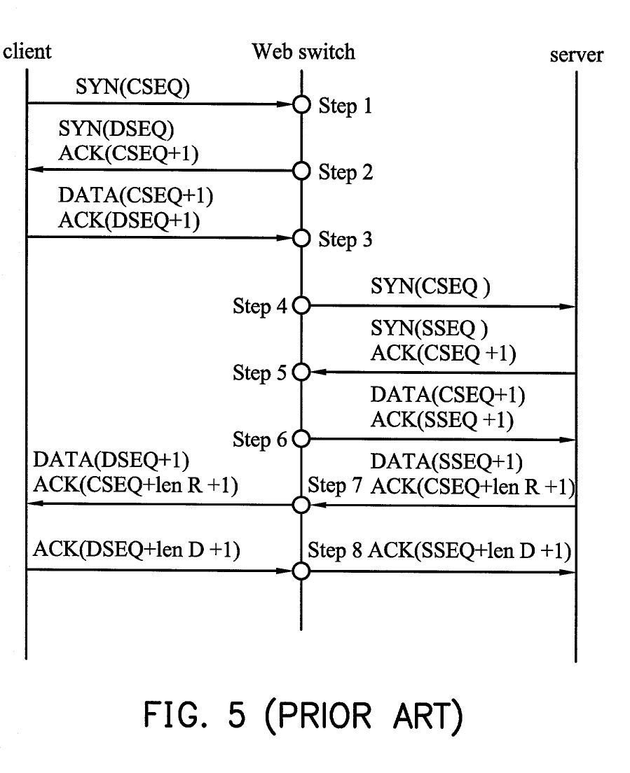

### DETAILED DESCRIPTION OF THE PREFERRED EMBODIMENT

The method for forming a Website server cluster structure of the present invention has two portions. The first is website building and the second network configuration.

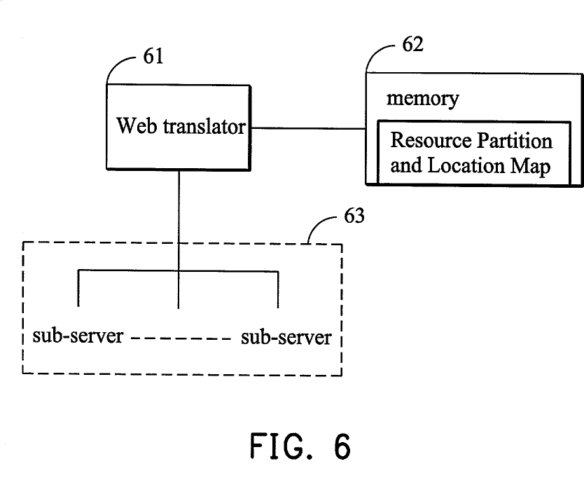

In the fist portion, the Website builder also builds Web pages in conventional methodical way. After the Website is finished, all content and predetermined rules are input to an automatic Web translator to induce heterogeneous Web server cluster content. As shown in FIG. 6, the structure comprises a Web translator 61 for producing a Resource Partition and Location Map, a memory 62 for storing the Resource Partition and Location Map and a plurality of sub-server 63. The Web translator 61 is implemented using an IC. The present method can be applied to a Website that has already operated online. By producing a heterogeneous Web server cluster, the Website builder defines rules beforehand to the Web translator. Thereby, Web page resources can be optimized.

The resource of the original Website produces partitioned and translated Web data that can be installed in servers by dispatching and converting. The resource in each server is only a portion of the resources of the original Website. The resource in each server is not the same after translation by the automatic device 61. At this same, the automatic device 61 produces a Resource Partition and Location Map. The Resource Partition and Location Map is stored in the memory 62 to refresh the translated data quickly. The translated resource adds a predetermined path to each path of the objects or instead of the original path. An example illustrating the method mentioned above follows:

Original Webpage

<IMG SRC=“images/invisi.gif” WIDTH=“9” HEIGHT=“1”>

<IMG SRC=“images/index_newsrel.gif” ALIGN=“top”>

<a href=www.riginial.com/channel/morsearch.HTML>Search Engine</a>

<img height=1 src=“img/b5/spacer.gif” Width=90>

<a href=“r/s/gcard/Yahoo! Gift Card</a><br>

The Static Webpage of the Present Invention

<IMG SRC=” http:/imqsrvl.partition.com/images/invisi.gif” WIDTH=“9” HIGHT=“1”>

<IMG SRC =“http:/imqsrv3.partition.com/images/index_newsrel.gif” ALIGN=“top>

<a href=www.riginial.com/channel/morsearch.HTML>Search Engine</a>

<img height=1 src=“http:/imqsrv3.partition.com/img/b5/spacer.gif” Width=90>

<a href=” http:/imqsrv4.partition.com/r/s/gcard/Yahool! Gift Card</a><br>

Wherein k in the “http://imqsrvk.partiton.com/” is k=1-4,

this predetermined path is an absolute address for searching the Web page quickly.

According to the optimum definition, the translated path can only add an absolute address like a URL of a server to the original address, or change the path completely. The resource of a Web page is distributed to different servers, and the automatic device 61 decides how to add the absolute address to the original address, according to the Website structure and the user-defined rules.

The second portion is server building, installing the separated resource to each server, and inputting the location, as address, according to the data to each server.

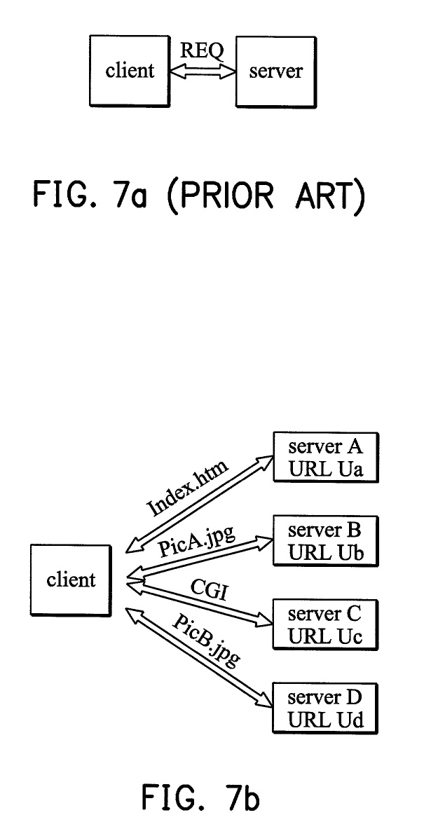

For Web page users, the display is the same, only differing in source code. Practically, the access action of the present invention requests resources from several servers, not only from one server, as shown in FIG. 7(a). In the distributed access Website, low level servers are used instead of high level servers since data has been separated and distributed to several servers to decrease networking structure implementation costs.

FIG. 7(b) shows a distributed access Website illustrating the access actions of the client browser. The browser obtains predetermined HTML (Index.htm) by the predetermined address (URL Ua), links to server B with URL Ub by decoding the source code of the predetermined HTML for getting “PicA.jpg”, and to server D with the predetermined address (URL Ud) to get PicB.gif, such that the Web page is displayed completely. At the same time, the browser links to server C when the user clicks on the CGI on the Web page.

If the Website has refreshed, the automatic device 61 adds the resource to the server cluster according to a new input 5 Resource Partition and Location Map including the original and new portion. Also, the entire Website can be translated, but refreshing the new portion of the Website is faster when the new portion is small.

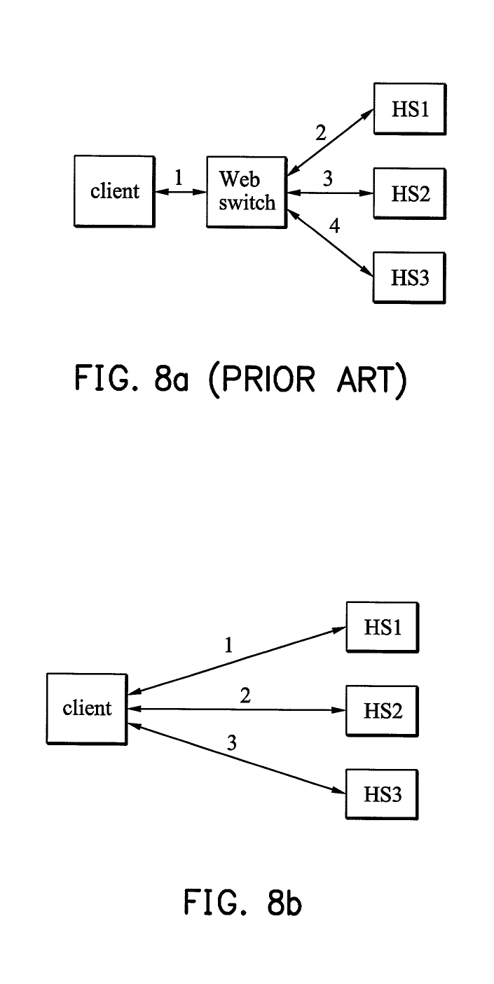

As shown in FIG. 8(a) and FIG. 8(b), each client must have a connection to each heterogeneous server to access resources, such that the loading of the server is similar. However, for whole system performance of the Web switch system, the Web switch must be added between the client and server (so that the delay time between clients and servers is increased, namely, the response time between clients and servers is increased) Further, the whole implementation cost of building the system is increased due to the addition of a Web switch to the system.

Furthermore, it is very hard to optimize the whole Website with a Web switch. When the administrator wants to separate resources of the Web page slightly, the commands that the Webmasters need to consider are very complex and difficult to administer. In the present invention the Webmaster only inputs the configuration to the automatic device to optimize the whole Website.

In the present invention, if the Web pages of the Website are dynamic Web pages, the automatic device 61 must recognize the programming language that the dynamic Web page uses, and optimize the Website in each result. The present invention also can be applied to dynamic Web pages, but with difficulty, so, according to dynamic Web pages, another network structure is provided in the present invention.

First, when the Website is translated by the automatic device 61 to separate resources of the Website the same as the static Web pages, but not add the absolute address to the original address of resource of the dynamic Web page directly. Then, the automatic device 61 produces a Resource Partition and Location Map the same as a static Web page. The difference is that two type of heterogeneous servers must be produced according to the rules and resource definitions. One type is a server with partitioned dynamic Web Server resource, like Active Server Page(ASP), and the other is a server with partitioned and translated static data, like picture and HTML files.

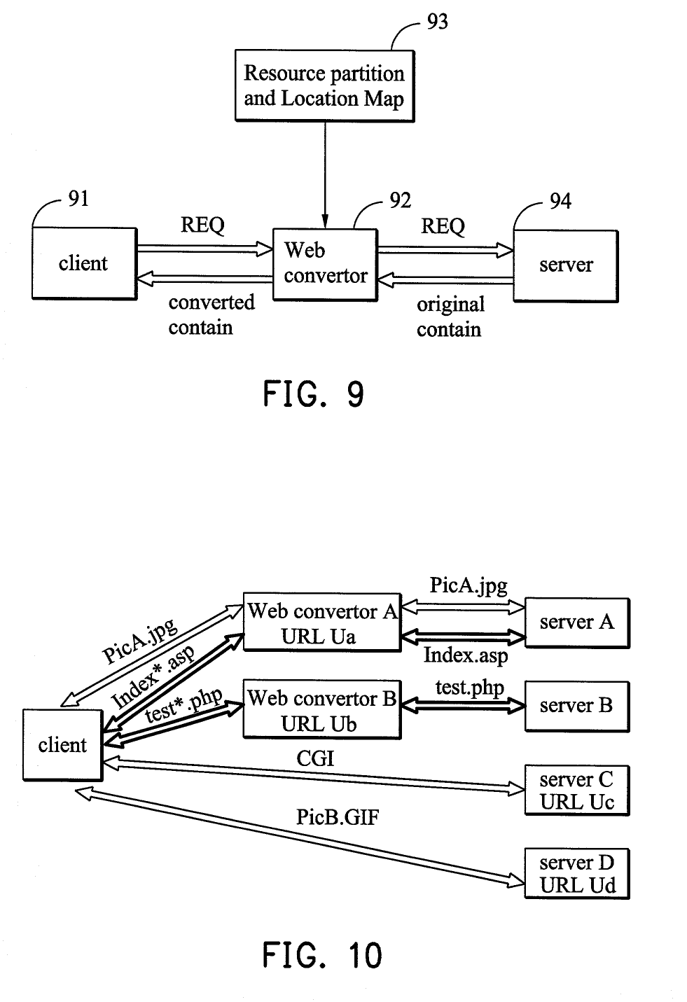

The server with partitioned and translated static Web pages are built by the method mentioned above, and the server with partitioned dynamic Web pages is built as FIG. 9 shows. A Web converter 92 is added in front of the separated server 94, the Partition Resource and Location Map from memory is input to the Web converter 92, and the Partition Resource and Location Map is produced from a Web translator. The client 91 communicates with the server 94 through the Web converter 92. When the server 94 sends a Web page with original addresses to Web converter 92, the Web converter 92 converts the original address into distributed server address according to the Partition Resource and Location Map.

When each server is built by the method mentioned above, the operation of the Website is shown as FIG. 10. If the data requested by a client is in the static Web servers, such as server C and server D, the client links to server C and server D directly to fetch resources. If the resource requested from the client is in the dynamic Web servers, such as server A and server B, an HTML file with the resource path is sent to Web converter A or B. Then the Web converter A and B convert the resource path to the address of distributed Web servers A and B. For the HTML file, the resource, file “index.asp”, received from the dynamic server is different from the original Web page, file “index*. asp”. Similarly, file “test.php” is different from “test*.php”. In the present invention, a powerful Web converter is used instead of several weak Web converters, but the relationship between partition resource and location must be installed into the powerful Web converter.

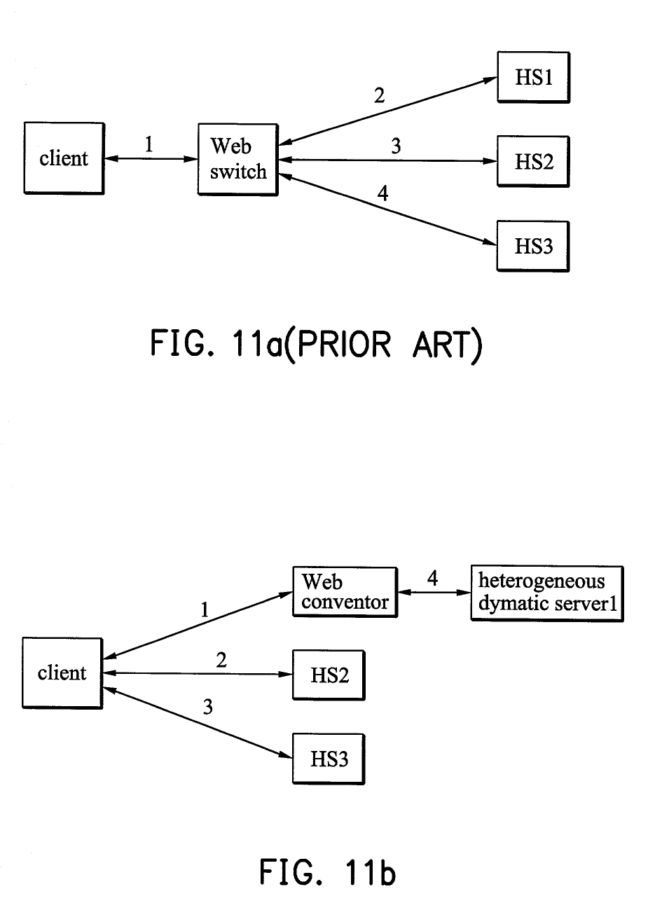

For Websites with dynamic Web pages, the connection between client and server of the invention and conventional methods are shown in FIG. 11(a) and FIG. 11(b). The linking amounts of client and servers in the present are the same as the linking amount of Web switch in conventional methods. However, the required throughput of the Web converter is smaller than the Web switch, so the method of the present invention is also better than conventional methods. The resources of the static Web page servers are delivered to client without adapter, thereby the performance request of the adapter (Web translator) is decreased.

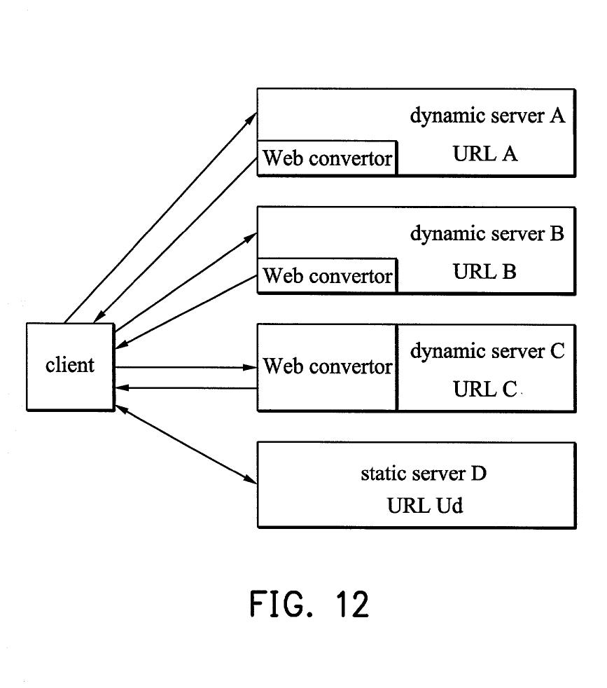

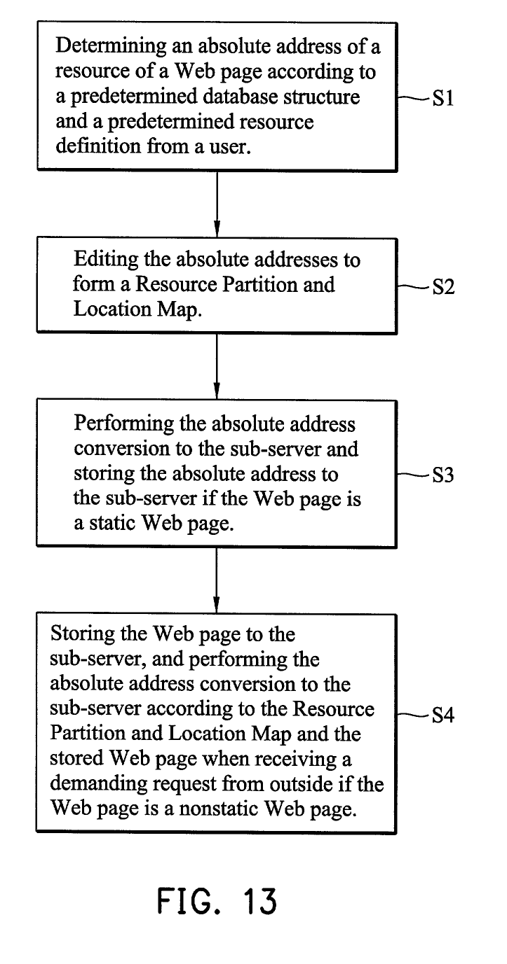

Web translators can not only be implemented in front of the servers in an IC form, but also in the servers in a software module, as FIG. 12 shows. The module only converts the resources in the output portion as the module in server A. The same as the module in server A, the module is capable of converting address of the resource according to the Partition Resource and Location Map in the output portion. If the module is applied in server C, the client requests in the past can be recorded. After certain calculations of the client requests, the client requests are dynamically converted and sent back to the path of the resource. As well, the program for processing dynamic Web pages can also be modified to insert the software module between the program and the network interface.

In view of this, the present invention provides a method of forming a Web server cluster, comprising determining an absolute address of a resource of a Web page according to a predetermined database structure and a predetermined data definition, editing the absolute addresses to form a Resource Partition and Location Map, performing the absolute address conversion to the sub-server and storing the absolute address to the sub-server if the Web page is a static Web page, storing the Web page to the sub-server, and performing the absolute address conversion to the sub-server according to the Resource Partition and Location Map and the stored Web page when receiving a demanding request from outside if the Web page is a nonstatic Web page.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of forming a Website server cluster structure, wherein the server cluster structure comprises a sub-server, comprising:
determining an absolute address of a resource of an Web page according to a predetermined database structure and a predetermined data definition;
editing the absolute addresses to form a Resource Partition and Location Map;
performing the absolute address conversion to the sub-server and storing the absolute address to the sub-server if the Web page is a static Web page; and
storing the Web page to the sub-server, and performing the absolute address conversion to the sub-server according to the Resource Partition and Location Map and the stored Web page when receiving a demanding request from outside if the Web page is a nonstatic Web page.

2. The method of forming a Website server cluster structure as claimed in claim 1, wherein the nonstatic Web page is a dynamic Web page implemented in a dynamic sub-server.

3. The method of forming a Website server cluster structure as claimed in claim 1, wherein the Resource Partition and Location Map is stored in a storage device.

4. The method of forming a Website server cluster structure as claimed in claim 3, wherein the storage device is a memory with a storage function.

5. The method of forming a Website server cluster structure as claimed in claim 1, wherein the absolute address conversion is performed by a Web translator if the Web page is a static Web page.

6. The method of forming a Website server cluster structure as claimed in claim 1, wherein the absolute address conversion is performed by a Web converter, if the Web page is a dynamic Web page.

7. The method of forming a Website server cluster structure as claimed in claim 6, wherein the Web converter is a dependent IC device implemented in hardware circuitry.

8. The method of forming a Website server cluster structure as claimed in claim 6, wherein the Web converter is a software module that is an integrated portion of the sub-server.

9. The method of forming a Website server cluster structure as claimed in claim 6, wherein the Web converter is a separately implemented software module that is a portion of the sub-server.

10. A structure for forming a Website server cluster structure, comprising:
an automatic device for producing a Resource Partition and Location Map;
a storage device for storing the Resource Partition and Location Map;
a plurality of sub-servers for implementing a partitioned and translated resource by dividing and converting an Web page according to the Resource Partition and Location Map.

11. The structure for forming a Website server cluster structure as claimed in claim 10, wherein the plurality of sub-servers comprise at least a static Web sub-server and a dynamic Web sub-server.

12. The structure for forming a Website server cluster structure as claimed in claim 10, wherein the plurality of sub-servers are static Web sub-servers.

13. The structure for forming a Website server cluster structure as claimed in claim 10, wherein the automatic device is a Web translator.

14. The structure for forming a Website server cluster structure as claimed in claim 13, wherein the Web translator is implemented in the static sub-server, and the Web translator is used to convert the resource address output from an external server into an absolute address for the static sub-server.

15. The structure for forming a Website server cluster structure as claimed in claim 13, wherein the Web translator is a host.

16. The structure for forming a Website server cluster structure as claimed in claim 11, further comprising a Web translator implemented in the dynamic sub-server, and the Web translator is used to convert the resource address output from an external server into an absolute address for the dynamic sub-server.

17. The structure for forming a Website server cluster structure as claimed in claim 16, wherein the Web converter is a dependent IC device implemented by hardware circuitry.

18. The structure for forming a Website server cluster structure as claimed in claim 13, wherein the Web converter is a software module that is an integrated portion of the subserver.

19. The structure for forming a Website server cluster structure as claimed in claim 13, wherein the Web converter is software module that is a separately implemented portion of the sub-server.

20. The structure for forming a Website server cluster structure as claimed in claim 13, wherein the storage device is a memory with storage function.
